(19) United States
(12) Patent Application Publication
(10) Pub. No.: US 2018/0301743 A1
(43) Pub. Date: Oct. 18, 2018

(54) METHOD AND APPARATUS FOR MANUFACTURING ENERGY STORAGE DEVICES

(71) Applicant: TUBZ, LLC, Houston, TX (US)

(72) Inventor: Jaim NULMAN, Palo Alto, CA (US)

(21) Appl. No.: 15/951,792

(22) Filed: Apr. 12, 2018

Related U.S. Application Data
(60) Provisional application No. 62/486,478, filed on Apr. 18, 2017.

(51) Int. Cl. H01M 10/058; H01G 11/84; H01G 11/80

(52) U.S. Cl. CPC H01M 10/058; H01G 11/58; H01G 11/80; H01G 11/84

(57) ABSTRACT

A method of drying and preparing the interior surfaces of a case of an energy storage cell having at least one opening extending from the interior volume thereof to the exterior thereof prior to the filling thereof with an electrolyte media, and an apparatus therefor, includes providing a media managing and dispensing unit and sealingly connecting it to the at least one opening into the case, introducing dry gas from the media managing and dispensing unit into the interior volume of the case and exhausting the gas from the interior volume of the case, and thereafter sealing the at least one opening.

### CROSS-REFERENCE TO RELATED APPLICATIONS

This application claims the benefit of U.S. provisional patent application Ser. No. 62/486,478, filed Apr. 18, 2017, which is herein incorporated by reference.

### BACKGROUND OF THE INVENTION

### Field of the Invention

The present disclosure relates to the field of energy storage devices, more particularly, rechargeable energy storage devices.

### Description of the Related Art

Rechargeable energy storage devices, such as batteries and ultracapacitors, require the use of ultra dry rooms for assembly of the physical components thereof, such as the electrodes and separators, into a case of the energy storage device, for the addition of internal connections and terminals into the case, as well as for the placement of safety features such as vents into the case. Alternatively, once these components are assembled into the case, the case may also be heated and dried under vacuum conditions in a dry room to ensure that no moisture is present on, or in, the surfaces thereof.

Once it is clear that the physical components of the battery are dry, and within the dry room, the electrolyte is added into at least one fill port in the case. These dry rooms are costly to operate, such that each cubic foot thereof that can be reduced leads to savings directly to the cost to build the manufacturing facility, and thus the profitability of the manufacturing enterprise. They require special air handling and particulate handling systems to ensure the environment therein is ultra-dry, employee health can suffer from prolonged exposure to the dry room environment, and special entry and exit portals are required to maintain the ultra-dry environment therein. However, dry room manufacturing has been deemed as necessary for battery and ultracapacitor manufacture, because electrolytes, such as Lithium Hexafluoride (LiPF6), will react with water based moisture to form hydrofluoric acid (HF). Hydrofluoric acid is poisonous, corrosive, and if exposed to the skin, can penetrate through the skin and attack underlying tissue and bone, as well as corrosively destroy exposed skin tissue. Additionally, the electrolytes, when exposed to moisture, i.e., H2O, will generate (evolve) gases, including oxygen, which can cause the sealed case to deform, which can cause the anode and cathode to shift therein potentially short circuiting the battery, changing the spacing between the anode and cathode, and cause the external connections to the battery to become electrically isolated from one or both of the anode and cathode. In addition, during manufacture, impurities which could interact with the electrolyte or the Li ions thereby degrading the performance of the energy storage device, or which could become a source for the formation of dendrites in the energy storage device during use, may be left on the interior surfaces of the cell and degrade the performance of the energy storage device or limit the manufacturing yield of ultracapacitors or batteries from the manufacturing process.

### SUMMARY OF THE INVENTION

The present invention fundamentally changes the way the battery, ultracapacitor or other liquid filled energy storage devices are assembled, and eliminates the need for a dry room, by the use of built in ports in the cell battery casing by which the interior surfaces of the battery, ultracapacitor or other liquid filled device which will be exposed to the electrolyte are dried, and then maintained in a dry state, until the electrolyte comes into contact therewith and the case is sealed. To enable this result, the case is assembled in a non dry-room environment, and equipment is provided to extract the gaseous environment from within the assembled case to form a sub-atmospheric condition (vacuum) therein, bake the device while the internal volume thereof is maintained at vacuum conditions and the interior volume is pumped to remove any contaminants outgassed from the case internal walls and the cell components therein, inject the electrolyte into the interior volume, and, if required, provide a cure step. The built in ports are sealed at the end of the process, or other components are integrated into the fill. The processes and apparatus herein are described in relation to energy storage devices including prismatic, pouch, cylindrical and other form factors, including ones with no rigid walls. However they are equally applicable, and enhance the production and safety of production of, any battery, ultracapacitor or other liquid filled devices where moisture affects the safety, operation or yield of the devices, and/or where there is a desire to add or circulate additional fluids to be physically incorporated into the interior surfaces or components of the device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic outlining the liquid filling system hereof;

FIG. 2 is a schematic view of an energy storage device and a drying and filling system for drying the interior surfaces of the device and filling the device with electrolyte;

FIG. 3 is a schematic view of an energy storage device and a first alternative drying and filling system for drying the interior surfaces of the device and filling the device with electrolyte;

FIG. 4 is a schematic view of an energy storage device and a second alternative drying and filling system for drying the interior surfaces of the device and filling the device with electrolyte; and

FIG. 5 is a schematic view of the energy storage device, the drying and filling system, and an immersion tank useful for heating the cell and applying vibration thereto.

### DETAILED DESCRIPTION

The present invention is based on the use of a one or more access ports integrated into, or sealingly secured to, the casing of the energy storage device to enable drying and purifying of the internal surfaces thereof in a non-dry environment, and to manufacturing equipment that provides gases, liquids, heat, vibration, vacuum, sealing, and assembly of the access port into the casing of the battery, ultracapacitor or other liquid filled device through the access port or ports. Herein, once all of the energy storage device elements and the casing of the energy storage device or other liquid filled device have been assembled together, the energy storage device elements and the internal surfaces of the casing of the device are cleaned, dried or purified, and filled through the openings provided by the access port(s) without the interior of the device being further exposed to the ambient conditions within the manufacturing environment, and thus the energy storage device need not be manufactured, nor maintained, in the ultra-dry conditions prior to the sealing thereof as dictated in the prior art. Additionally, the methods and apparatus herein allow the energy cell portion of the device to be conditioned, such as by the introduction therein of fluid based additives, without the need to do so in an ultra-dry condition. Thus, provided herein are a manufacturing apparatus and a method of managing the process of preparing the assembled energy storage cell for the introduction of the electrolyte and, where desired, other additive materials, introducing the electrolyte and, where desired, other additive materials, conditioning the filled cell, and sealing the access port(s).

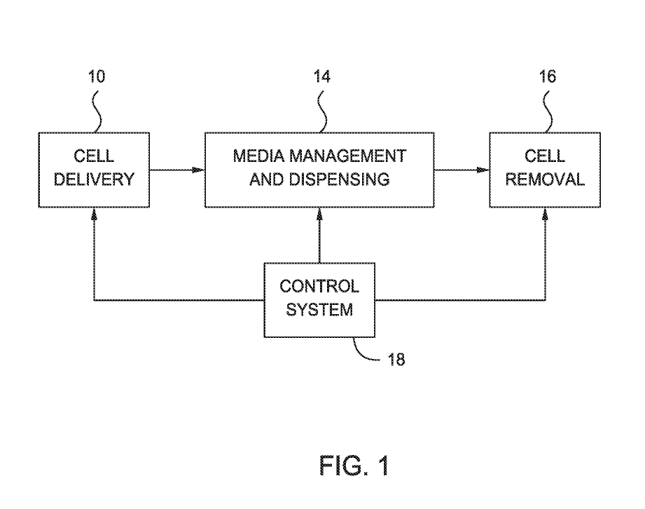

The apparatus described herein provides a unique implementation for handling the preparation of the device (cell) case for the introduction of the electrolyte and sealing of the interior thereof after completing the filling process, such that the internal components of the device are not exposed to ambient air once the unit comprising the case, the electrodes and separator(s), and internal portions of connection components, is delivered to, and connected to, the apparatus by the material handling system. The apparatus includes a material handling system for delivery of the configured cell having the electrodes, separator(s) and connection components assembled therein, to a drying and filling location, either manually or automatically, a media management and dispensing unit, a computerized control system, and a material handling system (which may include manual handling) to load the case with having the electrodes, separator(s) and connection components therein, and remove of the sealed and completed cell from, the drying and filling location, as shown schematically in FIG. 1.

The assembly of the case and the electrodes, separator(s) and connection components therein, and the delivery step and cell removal step with respect to the media management and dispensing unit, are accomplished by any material handling system available on the market that is adapted for transporting the particular shape of the case, or by manually placing a configured cell but not yet completed cell which includes the case, the electrodes, separator(s) and connection components therein, and removing the completed cell, from the media dispensing area facility location. For example, a conveyor and a robot may be provided in conjunction with an imaging system, such as a digital camera, and a control system such as a computer programmed to receive a digitized image of the energy storage case of the cell and control the movement of the conveyor.

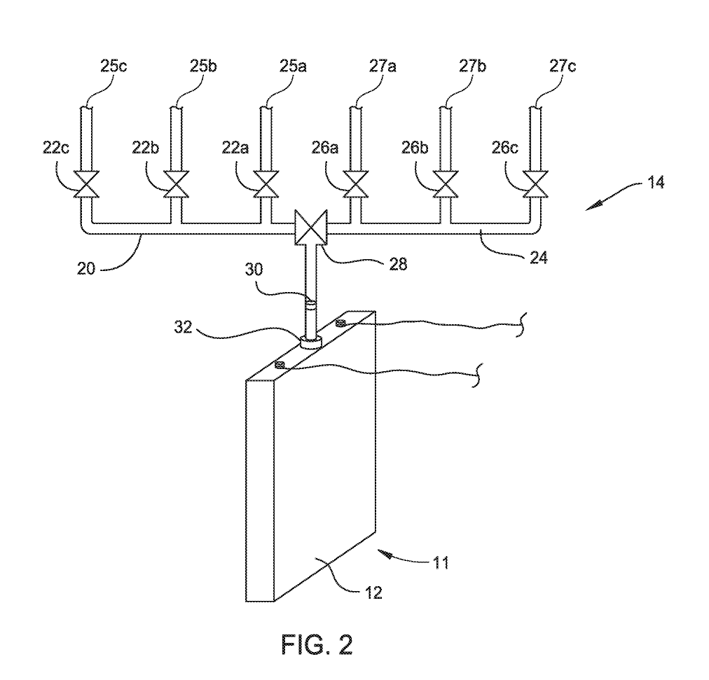

Referring initially to FIG. 1, the process of filling the case 12 (FIG. 2) starts by the step of delivery 10 of the case 12 having the electrodes, separator(s) and connection components therein to a media dispensing area of a facility, where it is filled using a media management and dispensing unit 14. Here, the case 12 is the case for an energy storage device such as a battery or ultracapacitor, having the solid physical components, including the electrode(s) and separator (s) assembled therein, and the case 12 in which these components are held is closed and sealed, but for access ports used by the media managing and dispensing unit 14 which open thereinto from an exterior location. A conveyer and robot system are, for example, used for transport of the energy storage case 12 (FIG. 2). Once the energy storage case 12 having the electrodes, separator(s) and connection components therein reaches an appropriate location in the media dispensing area, i.e., the drying and filling location, the robot makes and secures the connection between the media management and dispensing unit 14 and the energy storage cell case 12. Once the energy storage cell case 12 has been filled with media, such as electrolyte, and sealed and disconnected from the media management and dispensing unit 14, the robot moves the completed cell 11 and positions it to be removed from the drying and filling location of the facility by the conveyor in the cell removal step 16. The control system 18 also controls the operation of the media managing and dispensing unit 14, as will be described further herein. Additionally, where the filling operation is automated, the movement or positioning of the case 12 and resulting energy storage cell 11, and of the media management and dispensing unit 14, in the cell delivery, filling, and cell removal steps is controlled by the control system 18.

Because the media management and dispensing system 14 is configured to dry the interior surfaces of the case 12 of the energy storage cell 11, including the portions of any connections having an internal volume exposed to the interior of the energy storage case 12, the electrolyte dispensing area of the facility need not be an ultra-dry environment. Hence, the cost to build and maintain a large dry room space is reduced or eliminated.

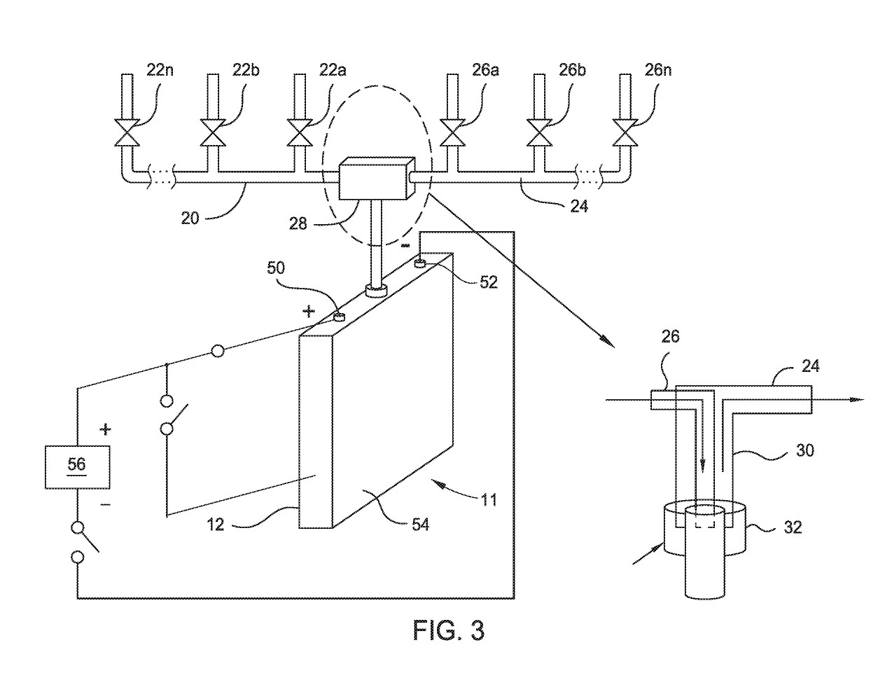

In one implementation, as shown in FIG. 2, the Media Management and Dispensing (MMD) unit comprises a first manifold 20, at least one media supply valve 22 (22a, 22b, . . . 22n) coupling the first manifold 20 to a supply 25a, 25b, 25c of media, a second manifold 24, at least one outlet valve 26 (26a, 26b, . . . 26n) coupled to the second manifold 24 to exhaust piping to exhaust the contents of the second manifold 24, a selection valve 28 for selectively fluidly connecting one or both of the first and second manifolds 20, 24 to a fill tubing 30 extending therefrom, or to fluidly connect the first and second manifolds 20, 24 to each other and not to the fill tubing, and a coupling 32 disposed at the end of the fill tubing 30 distal from the selection valve 28. The fill tubing 30 is shown, in FIG. 2, as a single walled tube, but could be double walled as shown in FIG. 3, such that the media can enter the energy storage cell case 12 through the central opening thereof, and any dry air or inert gas or other material therein can be removed through the annular portion surrounding the central opening. In the embodiments shown in FIGS. 2 to 4, the media management and dispensing unit 14 includes n inlet valves, valves 22a, 22b . . . to 22n connected to first manifold 20, where n is a whole number, and n outlet valves, valves 26a, 26b . . . to 26n connected to the second manifold 20, where n is a whole number.

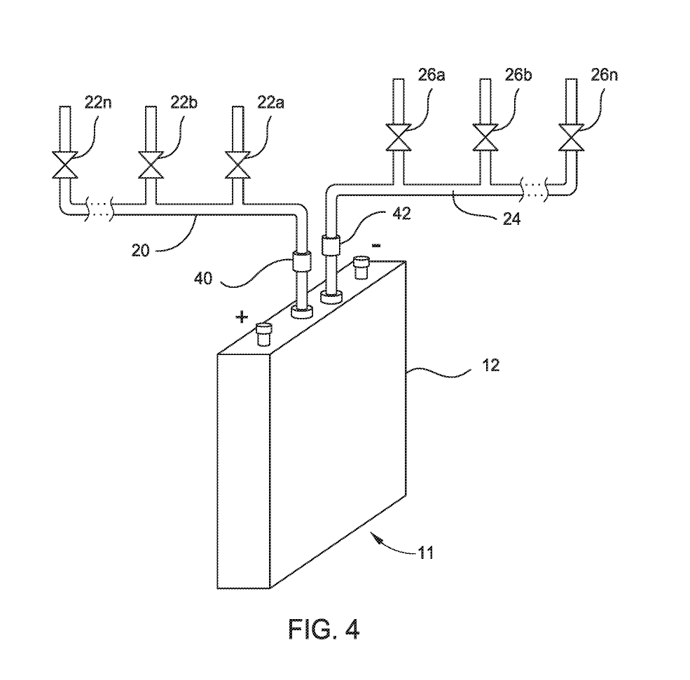

The case 12 configurations shown in FIGS. 3 and 4 allow for continuous flow of dry air or dry inert gas, and of the filling Media, into and out of the cell. The sequencing operation of the valves is preferably managed by the control system 18, but manual operation is also possible.

In the implementation as shown in FIG. 4, the media management and dispensing unit 14 is connected to the case 12 of the resulting energy storage cell 11 using two independent ports integral to the case 12 and in fluid communication with the interior of the case 12, one port for dry air or dry inert gas introduction and for media delivery, and the other port for dry air or dry gas removal and for media evacuation. The ports may, for example, have a threaded, or other, outer circumferential surface, and a thin continuous covering over the portion thereof distal from the internal volume of the cell, or be open at the end thereof distal from the internal volume of the case 12. Where the ports have the continuous covering, they maintain the interior volume of the case in isolation from the surrounding ambient environment, and thus allow the cells to be manufactured and stored an indefinite period of time before being filled with electrolyte. In this embodiment, the thin covering is pierced by the filling tubing 30 to dry the internal components and surfaces thereof, and to introduce the electrolyte thereinto.

The method of filling the cell of FIGS. 2 and 3 with a liquid electrolyte consists of first purging the energy storage cell case 12 with an inert and ultra-dry gas, such as dry air, nitrogen or argon, or combinations thereof. Before purging of the energy storage cell case 12, the first and second manifolds 20, 24, and the volumes of the valves 22a-n and 26a-n exposed thereto when closed, are first purged to remove moisture therefrom. This can be accomplished by positioning the selection valve 28 to cause the first manifold 20 and the second manifold 24 to be in fluid communication with each other and isolated from the filling tubing 30, and configuring the outlet of one of the outlet valves 26a-n to be maintained at a relatively high vacuum, for example valve 26n. While maintaining all of the inlet valves 22a-n in a closed position, and all of the outlet valves 26 other than outlet valve 26n closed, the outlet valve 26n is opened and the high vacuum state of the outlet of outlet valve 26n causes the interior volume of the first and second manifolds 20, 24, and the interior volumes of the inlet valves 22a-n and outlet valves 24a-n exposed to the interior of the first and second manifolds 20, 24, to be exhausted down to the vacuum pressure on the outlet through outlet valve 26n. To further reduce the presence of moisture on the interior surfaces of the first and second manifolds 20, 24, and the surfaces of the valves 22, 24 exposed thereto, the manifold and valves can be heated, such as by electric resistance wire heating, blanket heating, infrared heating, induction heating, or the like, prior to, and during, the gas purging thereof. Heating of the first and second manifolds 20, 24 and valves 22, 26 under vacuum conditions on the interior surfaces thereof will enhance the removal of water vapor therefrom. Next, one of the inlet valves 22, for example valve 22n, which is connected to a supply of dry air or a dry inert gas is opened, while the positions of the selection valve 28 and the remaining inlet valves 22 and outlet valves 26 remain unchanged, and the dry gas comprising at least one of dry air or dry inert gas, is flowed through the first and second manifolds 20, 24, past the interior facing surfaces of the inlet and outlet valves 22, 24, and through the selection valve 28, further causing moisture in the exhausted interior volumes thereof to be carried away in a dry gas stream and out of outlet 26n. Preferably, a dry inert gas is used. The gas exhausted through the outlet valve 26n can be recovered by flowing it into a reservoir, filtered through a moisture/oxygen trap, and re-used resulting in lower cost as compared to disposing of the gas. In another implementation of this procedure, the inert gas is heated to a preset temperature prior to arriving to the cell, typically a temperature in the range of between 40° C. to 150° C., and more typically between 80° C. to 110° C., to also heat the internal surfaces of the manifolds 20, 24 and valves 22 and 26.

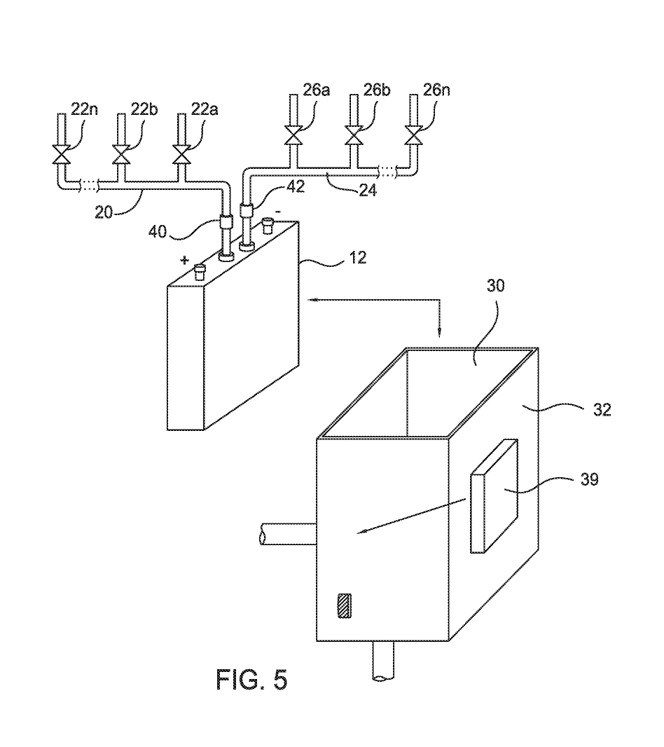

Once the inlet and outlet manifolds 20, 24 and the interior volumes of the valves 22, 26 have been treated to remove moisture therefrom, moisture is additionally removed from the interior surfaces of the energy storage cell case 12 using the media managing and dispensing unit 14. At this point, the coupling 32 is pressed over a nipple extending from the case 12 wall, to form a gas tight seal therewith. Alternatively, where the thin continuous covering is present, the coupling is configured to pierce the covering to open fluid communication with the interior of the case 12, while sealing around the pierced region. Then, the selection valve 28 configuration or setting is changed to allow dry gas, preferably dry inert gas at an elevated temperature of between 40° C. to 150° C., and more preferably between 80° C. to 110° C., to flow from the inlet valve 22n, through the first manifold 20 and a first configured passage of the selection valve 28, and into the interior volume of the energy storage cell case 12, and thereafter the selection valve 28 setting is changed to close off the communication between inlet manifold 20 and the interior of the energy storage cell case 12, and allow fluid communication between the outlet manifold 24 and the interior of the energy storage cell case 12, causing the dry gas to flow out through the selection valve 28 isolated from the first configured passage thereof, into the second manifold 24 and out through outlet valve 26n. The selection valve 28 is now operated to disconnect the interior of the energy storage cell case 12 from the outlet manifold 24 and outlet valve 26n, and to fluidly connect the interior volume of the energy storage cell case 12 with the inlet manifold 20 and inlet valve 22n, followed by closing off the communication between inlet manifold 20 and the interior of the energy storage cell case 12, and again allowing fluid communication between the outlet manifold 24 and the interior of the energy storage cell case 12, and thus cause the dry gas to flow out through the selection valve 28 isolated from the first configured passage thereof, into the second manifold 24 and out through outlet valve 26n. This cycle of alternately sealing off the interior of the energy storage cell case 12 from the inlet and outlet manifolds 20, 24 is repeated until the internal surfaces thereof are at the appropriate level of dryness, wherein the quantity of oxygen and water vapor on the surfaces is between 8 and 20000 ppb, more typically 100 to 2000 ppb. Alternatively, a continuous purge of dry, inert, heated gas from the inlet valve, for example inlet valve 22n, into the interior of the case 12, and then out to the outlet valve maintained at vacuum such as valve 26n can be employed. In addition, or in lieu of heating the dry inert gas flowing through the interior volume of the case 12, the case 12 can be inserted up to a level thereof greater than an unsafe distance from the top edge of the case 12 into a reservoir with a media, typically a liquid, held at a desired elevated temperature, as shown FIG. 5, while inert gas is flowed therethrough. Alternatively, the case 12 can be heated using electric resistance wire heating, blanket heating, infrared heaters, induction heating, or the like, while a dry gas, which may or may not be preheated, is passed therethrough. In the event of using a hot gas, the hot liquid reservoir and or the other described mechanisms and methods of heating the case 12, the heating step is followed by flowing room temperature dry inert gas or other dry and cold media in the reservoir in order to cool down the cell. Preferred gases are dry Ar, dry nitrogen and dry air. Additionally, where the exposure of the interior surfaces of the cell to the manufacturing environment has caused oxidation or other negative chemical reaction on the surface, an appropriate reactant can be first flowed into and from the cell in a repeated manner to remove the oxide layer or other detrimental film on the interior surfaces of the case 12. As an alternative, a continuous flow of dry gas can be flowed to effectuate the drying of the interior volume of the cell case.

After drying the interior volume and surfaces of the case 12 of the resulting energy storage cell 11, the dryness of the interior surfaces may be checked by closing off fluid communication from inlet manifold 20 to the interior volume of the case 12 using the selection valve 28, and exhausting the volume to a desired vacuum pressure, followed by closing the outlet valve 26n connected to vacuum or fluid communication between the outlet manifold 24 and the interior volume of the case 12 using the selection valve, and determining if the pressure in the interior volume of the case 12 increases, which is a sign of moisture escaping from the interior surfaces of the case 12 and the interior surface thereof being inadequately dried. If the outlet manifold 24 is maintained in fluid communication with the interior of the case 12 while the dryness is being evaluated, a vacuum gauge may be provided on the non-manifold side of one of the inlet valves 22 other than inlet valve 22n or an outlet valve 26 other than outlet valve 26n and the other valve opened, and thence valves 22n and 26n are closed. Again, if the pressure increases, the interior volume of the energy storage cell will be considered inadequately dried. Alternatively, or additionally, a moisture and/or oxygen monitoring device is installed downstream of the outlet valve 26n through which the drying gas is flowing from the interior of the case 12, and used to determine the dryness condition of the interior volume, and hence interior surfaces of the case 12 and the components therein. This step can be followed by an optional step of applying vacuum to the case after it is dry, to leave a reduced pressure in the interior cavity of the case 12 to enhance the performance of the electrolyte filling step.

Next, the case 12 is filled with the electrolyte in a liquid form without removing the case 12 from the connection with the media management and dispensing system 14. Electrolyte is flowed to the interior of the case 12 through one of the inlet valves 22 other than inlet valve 22n, and the selection valve 28 is positioned to cause the electrolyte to flow into the interior volume of the case 12. If required, the filling step can be done in stages, where the selection valve alternately enables communication between one of the inlet or outlet valves, and a portion of the electrolyte is flowed into the interior of the energy storage cell, the valve then connects the outlet manifold and the vacuum thereof applied through the outlet valve 26n to reduce the pressure in the interior of the case 12, and then switches back to allow electrolyte to flow from inlet manifold therethrough and into the interior volume of the energy storage cell. Alternatively, if a low enough pressure is present in the interior volume of the energy storage cell, the vacuum may not need to be applied to the interior volume and the interior volume may be maintained isolated from the outlet manifold by the selection valve 28. Once the case 12 is filled with a predetermined amount of electrolyte, which may be monitored with a flow meter in line with the Media In line connected to the valve 22 through which the electrolyte is flowing, the cell port (nipple) used for filling is crimped shut, or capped with a solid air tight cap.

Where a separate inlet port 40 and outlet port 42 are provided on the case 12 as shown in FIGS. 4 and 5, the interior of the case 12 can be maintained in communication with the vacuum pressure of the outlet manifold 24 as the case 12 is filed, and then both ports 40, 42 are crimped shut or capped with an airtight cap. Where the filling tubing is surrounded by an annular outlet, the vacuum can also be maintained while the cell is being filled with electrolyte. The vacuum pressure applied during filling is a higher pressure than that used to dry the case 12. The vacuum can be provided by a pump including vacuum pumps known in the art.

The media management and dispensing unit 14 thus provides the ability to fill the case 12 of the energy storage cell 11 immediately after drying and without exposure of the interior of the case 12 to the surrounding ambient and without the need to further move the case.

Depending on the type of electrolyte used, and in order to ensure the electrolyte penetrates into or on all of the required surfaces, the sealed case forming the energy storage cell 11 may need to be shaken. As shown in FIG. 5, the case 12 still connected to the selection valve 28 and inlet and outlet manifolds 20, 24 is immersed, or partially immersed, into a media 30 contained in a reservoir 32 where shaking thereof is performed, typically by inducing ultrasonic vibration on the media and thus on the case 12 and the internal components thereof, using an ultrasonic generator 34 affixed to one side of the media reservoir 32, prior to the sealing step of the cell, FIG. 5. This can be performed as the electrolyte is flowed into the case 12, or thereafter. By keeping the case 12 connected to the manifolds 20, 24 and thus the selection valves 22, 26, additional media can be flowed into the interior volume thereof if desired during or after the shaking/vibration step.

In other instances, the electrolyte is introduced in a liquid form per the method described above, but at least a portion thereof is intended to be converted to a solid. This is accomplished via a heat treatment. In this case the case 12 is lowered into a liquid bath at a preset temperature and for a preset time sufficient to solidify the media, and an outlet line connected to an opened valve 26 connected to the outlet manifold 24 is used to evacuate gases, if any, that are generated during the electrolyte solidification. This is followed by a final inert dry gas purge and sealing, such as by crimping or capping the inlet port 40 and outlet port 40, the inner and annular port, or the port described with respect to FIG. 2. The media in the reservoir 32 can be circulated, to initially provide a hot media, and then a cooled media to cool the energy storage cell before it is removed from the reservoir 32. Thus, it is preferred that the media be a liquid.

The liquid media described for the optional heating bath, for ultrasonic treatment, and cooling can be contained in a reservoir that is lifted up to a preset height instead of lowering the cell into it, then lowered when the process is complete, FIG. 5.

Depending on the materials used in the cell, gas generation can take place during the initial charge/discharge cycles of the battery. In such a case, the cell can be also connected to a charge/discharge circuitry and the generated gases evacuated prior to sealing the cell ports.

Some electrodes require the use of highly reactive materials such as Lithium to be incorporated (inserted or attached) into their structure as part of the manufacturing process. These materials are required in addition to the material deposited on, or removed from, the active surfaces during the charge and discharge cycles. In such a case complicated and expensive methods are required in order to protect these highly reactive materials from exposure to the ambient from the time at which the reactive materials are deposited or coated onto a cell component until they are assembled into the cell case 12 and the cell case 12 is sealed. The manufacturing process hereof enables a media containing the materials for incorporation to be introduced into a completed cell in a controlled case 12 interior environment, treating the case 12 to incorporate the materials into the corresponding structure in the controlled case 12 interior environment, and thereby not only provide a high-quality resulting material incorporation but also reducing the manufacturing steps required for the incorporation thereof. The media which contains the incorporation materials is then removed, the interior surfaces of the case 12 are cleaned and then dried as detailed above using dry inert gas purging. Thereafter, in some instances, these materials could be added to the actual electrolyte that is used for the operation of the cell after the cell manufacturing is completed. In some instances the incorporated materials may include excess material including Li which is purposely incorporated into the anode material forming a coating of Li of a desirable thickness resulting in a metallic Li anode, and hence an anode with the specific energy capacity of Li because this lithium stays on the anode at least in part and forms the active material and the active surface of the anode. Thus, as lithium is plated onto, and deplated from, the anode, it is plating onto, and deplating from, lithium, and not the underlying anode material. Since the same system dries the cell interior and introduces the electrolyte, the need for dry rooms is reduced and could be eliminated.

To provide the additional incorporation materials, the case 12 of FIGS. 4 and 5 having the cell components such as the electrodes and separator(s) and connections therein is cleaned and dried as discussed previously herein. Then, once in a dry condition, without removing the manifolds 20, 24 from the respective ports 40, 42 of the case 12, the media containing the additional materials, for example lithium, such as nanoparticles of lithium suspended or otherwise carried in an inert, to the lithium and to the interior components of the cell, liquid carrier, is flowed into the interior of the case 12. In this process, the inlet valve 22 among valves 22a, 22b, . . . 22n and the outlet valve among valves 26a, 26b, . . . 26n used to flow the media containing the additional materials are different than those used to clean and dry the interior volume of the case 12. The media may also include components useful to enhance a reaction between the lithium and selected surfaces within the interior of the case 12. Then, as shown in FIG. 3, the anode within case is maintained at a negative potential to another surface of the interior volume of the case 12 by connecting the negative output of a DC electrical source 56 to the external connection post 52 electrically connected to the anode, and the positive output of the source to one of the post 50 connected to the cathode within the case 12, or where the case 12 is electrically conductive, to the body of the case itself, of otherwise, and thereby causing the lithium to plate or otherwise attach and become integrated onto or into the surface of the anode. The control of the electrical source connection to the posts 50, 52 and the case 54 or other component is done under the control of, for example, the control system 28. The volume of media in the interior volume can be static, i.e., flowed therein and maintained in place during the deposition process, or dynamic, in that a fresh supply of media is flowed in while an equal amount of media is flowed out.

Once the depositing of the lithium has progressed to the endpoint, the flow of media is terminated, and a cleaning solution is flowed into the interior volume through one port (40) and exhausted therefrom through a second port 42, to remove residual media from the interior of the cell case. In this process, the inlet valve 22 among valves 22a, 22b, . . . 22n and the outlet valve among valves 26a, 26b, . . . 26n used to flow the cleaning solution is different than those used to clean and dry the interior volume of the case 12 or to flow the additional media. Thereafter, the interior surfaces of the valves 22, 26, and manifold 20, 24 and the interior of the case 12 and components therein are dried as described above, and then the electrolyte solution is filled therein, and the ports are sealed.

Alternatively, the media may comprise the electrolyte, except excess lithium is incorporated therein. In this case, the electrolyte may contain sufficient excess lithium to form a desired thickness of lithium on or in the anode, in which case the electrolyte may remain in the cell, or, the electrolyte used to deposit the lithium on the anode is replaced with electrolyte not having the excess lithium. In this case, the cell case may not need to be cleaned and re-dried before introducing the new electrolyte.

When additional lithium is added to the anode of the cell, gas is evolved. This gas can be removed as the gas is formed, through the outlet manifold 24 and an appropriate outlet valve 26, or the interior of the case sealed from the manifolds 20, 24 and thus valves 22, 26, and thereafter removed.

While the foregoing is directed to embodiments of the present invention, other and further embodiments of the invention may be devised without departing from the basic scope thereof, and the scope thereof is determined by the claims that follow.

1. A method of drying the internal surfaces of an energy storage cell case having at least one opening extending from the interior volume thereof to the exterior thereof prior to the filling thereof with an electrolyte media, comprising:
providing a media managing and dispensing unit and sealingly connecting it to at least one opening into the case;
introducing dry gas from the media managing and dispensing unit into the interior volume and exhausting the gas from the interior volume; and
thereafter sealing the at least one opening.

2. The method of claim 1, wherein the at least one opening comprises a first opening through which gas and media can enter the case, and a second opening is provided through which gas and media can exit the case.

3. The method of claim 2, wherein the second opening surrounds the first opening.

4. The method of claim 1, wherein the media managing and dispensing unit includes a first manifold having a first plurality of valves selectively opening thereinto, a second manifold having a second plurality of valves selectively opening thereinto, and a selection valve selectively allowing fluid communication between the first manifold and the second manifold.

5. The method of claim 1, further comprising a fill tube connected to the selection valve.

6. The method of claim 5, wherein the selection valve is configured to selectively fluidly interconnect at least one of the first manifold and the second manifold to the fill tube.

7. An apparatus for sequentially drying and filing a case having an interior volume, comprising:
a first manifold fluidly connected to a source of dry gas and a source of filling materials through at least one valved connection;
a second manifold fluidly connected to an exhaust through at least one valved connection;
a tube configured for fluid communication with the interior volume; and
a selection valve configured to selectively connecting the outlet tube to at least one of the first manifold and the second manifold.

8. The apparatus of claim 7, further comprising a second tube, and a second selection valve, wherein the tube is connected to one of the first and second manifolds through the selection valve and the second tube is connected to the other of the first and second manifolds by the second selection valve.

9. A method of depositing a material on an electrode in the interior volume of a cell case through at least one opening in the case before sealing the case; comprising
providing a media managing and dispensing unit and sealingly connecting it to the at least one opening;
introducing dry gas from the media managing and dispensing unit into the interior volume and exhausting the gas from the interior volume;
introducing a media containing the material to be deposited into the interior volume of the case through the opening, wherein a portion of the media deposits on the anode; and
thereafter sealing the at least one opening.

10. The method of claim 9, wherein the media is removed from the interior of the cell case through the at least one opening.

11. The method of claim 10, wherein an electrolyte is flowed into the interior of the case through the at least one opening after the media is removed.

12. The method of claim 9, wherein the media is an electrolyte with excess lithium therein.

13. A method of incorporating an additive into or onto an element of an energy storage cell located within an interior volume of a case, comprising;
providing a media managing and dispensing unit and sealingly connecting it to at least one opening into the case;
introducing the additive, incorporated into a liquid media, into the interior volume of the case using the media managing and dispensing unit; and
causing the additive to incorporate into or onto an element of the energy storage cell inside of the case.

14. The method of claim 13, further comprising, prior to introduction of the additive into the interior volume of the case:
introducing dry gas from the media managing and dispensing unit into the interior volume of the case and exhausting the gas from the interior volume of the case.

15. The method of claim 13, further comprising, after introducing the additive material into the interior volume of the case, introducing dry gas from the media managing and dispensing unit into the interior volume of the case and exhausting the gas from the interior volume of the case through the media management and dispensing unit; and
sealing the interior volume of the case from the exterior thereof.
